(19) United States
(12) Patent Application Publication
(10) Pub. No.: US 2006/0047715 A1
(43) Pub. Date: Mar. 2, 2006

(54) System and method for managing and analyzing data from an operational database

(75) Inventor: Doug Parizeau, Sherborn, MA (US)

Correspondence Address: LAHIVE & COCKFIELD, LLP., 28 STATE STREET, BOSTON, MA, 02109, US

(73) Assignee: Archer Analytics, Inc., Wellesley, MA (US)

(21) Appl. No.: 10/927,762

(22) Filed: Aug. 27, 2004

(51) Int. Cl. G06F 17/30

(52) U.S. Cl. 707/203

(57) ABSTRACT

A system and method for managing and analyzing data stored in an operational database, such as a Sales Force Automation (SFA) database, provides an analysis of changes to the data over time. An analytical database periodically obtaining a snapshot of an operational database. The analytical database identifies changes within the operational database between the snapshots. The analytical database can classify a type of change that has occurred within the operational database, and organize data copied from the database and calculated data indicative of the changes in the database in tables. The analytical database can provide a report containing information regarding changes in the database over time to a multidimensional analysis tool and/or back to the operational database to provide feedback regarding activity that is tracked by the operational database.

### FIELD OF THE INVENTION

The present invention relates to a system and method for managing and analyzing data from an operational database, such as that used in a Sales Force Automation (SFA) system.

### BACKGROUND OF THE INVENTION

Operational databases, such as those used as part of Sales Force Automation (SFA) systems, human resources information systems, inventory control systems and accounting systems, are useful software tools for automating data management and storage. These systems store data in a selected format. Operational databases can be used to track and manage various functions or features, such as customer contacts, sales opportunities, appointments, products, employees, sales orders, prices, time entry, expenses, and so on.

For example, Sales Force Automation systems use software to automate the business tasks of selling, including order processing, contact management, information sharing, inventory monitoring and control, order tracking, customer management, sales forecast analysis and employee performance evaluation. In SFA systems, information related to a sales function, including information about deals, potential deals, contacts, accounts, leads and sales activities, is stored in a suitable format in tables in a database.

A human resources database stores information about employees, and may have a record for each employee, where each record has fields for storing specific information about the employee, such as name, home address, salary and the like. Other examples of operational databases include databases for tracking inventory, managing appointments, time management, expense management, contact management, licensing, commission accounting, executive reporting, benefit provider library, and so on.

Drawbacks to current operational database systems are that current operational database systems merely provide an instantaneous view of the current state of activity being monitored therein. Current systems are not configured to track changes in the data over time to provide insight into or an analysis of the data stored within the database.

### SUMMARY OF THE INVENTION

The present invention provides a system and method for managing and analyzing data stored in an operational database, such as a Sales Force Automation (SFA) database. The present invention implements a method, using an analytical database, of periodically obtaining a snapshot of an operational database and identifying changes to data in the operational database to provide an analysis of changes in the operational database over time.

According to a first aspect of the invention, a method of managing data is provided, which comprises the steps of receiving, at a first point in time, a first copy of data stored in an operational database, receiving, at a second point in time, a second copy of data stored in the operational database, and comparing the first copy of data and the second copy of data to identify a change in the data stored in the operational database.

According to another aspect of the invention, an article of manufacture having computer-readable program means embodied thereon for managing data is provided. The article comprises computer-readable program means for receiving, at a first point in time, a first copy of data from an operational database. The article further comprises computer-readable program means for receiving, at a second point in time, a second copy of data from the operational database. The article also includes computer-readable program means for comparing the first copy of data and the second copy of data to provide a report identifying a change in the data between the first point in time and the second point in time.

According to another aspect of the invention, a method of managing data comprises the steps of receiving, at a first point in time, a first copy of data stored in an operational database and receiving, at a second point in time, a second copy of data stored in the operational database. The method further comprises the steps of comparing the first copy of data and the second copy of data to identify a change in the data stored in the operational database and entering a report identifying the change into a multidimensional analysis tool.

According to another aspect of the invention, an article of manufacture having computer-readable program means embodied thereon for managing data is provided. The articles comprises computer-readable program means for receiving, at a first point in time, a first copy of data from an operational database, computer-readable program means for receiving, at a second point in time, a second copy of data from the operational database, computer-readable program means for comparing said first copy of data and second copy of data to provide a report identifying a change in the data between the first point in time and the second point in time and computer-readable program means for entering a report identifying the change into a multidimensional analysis tool.

According to still another aspect of the invention, a method of managing transactional information relating to sales opportunities is provided. The method comprises the steps of receiving and storing a first copy of data from a SFA database, receiving and storing a second copy of data from the SFA database after a predetermined time period, and identifying changes to the data stored in the SFA database over the predetermined time period. In another aspect, an article of manufacture having computer-readable program means embodied thereon for managing data is provided, including computer-readable program means for executing these steps.

According to yet another aspect of the invention, a method of managing data is provided, which comprises the steps of storing, at a database, information indicative of a sales opportunity, executing at a database, a query producing a plurality of records including all stales opportunities stored in the database, and storing, at a first time period, the plurality of records at a data management server. The method further comprises the steps of updating the plurality of records in the database and storing, at a second time period, the updated plurality of records at the data management server.

### BRIEF DESCRIPTION OF THE FIGURES

The aforementioned features and advantages, and other features and aspects of the present invention, will become better understood with regard to the following description and accompanying drawings, wherein:

FIG. 1 is a block diagram of one embodiment of a Sales Force Automation (SFA) System suitable for use with an illustrative embodiment of the invention.

FIG. 2 is a block diagram of one embodiment of an example of a table for storing and organizing data in the SFA system of FIG. 1.

FIG. 3 is a block diagram of one embodiment of a management system for managing and analyzing data stored in the SFA system of FIG. 1.

FIG. 4 is a diagrammatic view of one embodiment of a table for storing and organizing data in the analytical database of FIG. 3.

FIG. 5 a diagrammatic view of one embodiment of a reference tool suitable for classifying a type of change undergone by an opportunity in a SFA system.

FIG. 6 a diagrammatic view of one embodiment of a table compiled by the management system of FIG. 3 for analyzing an opportunity tracked by an SFA system.

FIG. 7 a diagrammatic view of one embodiment of a table for compiled by the management system of FIG. 3 for displaying different types of changes undergone by an opportunity tracked by an SFA system.

### DETAILED DESCRIPTION OF THE INVENTION

The present invention provides a system and method for managing and analyzing data in an operational database. The present invention will be described with reference to the Figures. While the invention will be described in conjunction with an illustrative embodiment for a Sales Force Automation system, it will be understood that the invention is not limited to the illustrated embodiment and can be implemented for any suitable operational database. To the contrary, it is intended to cover alternatives, modifications, and equivalents as may be included within the spirit and scope of the invention as defined by the appended claims.

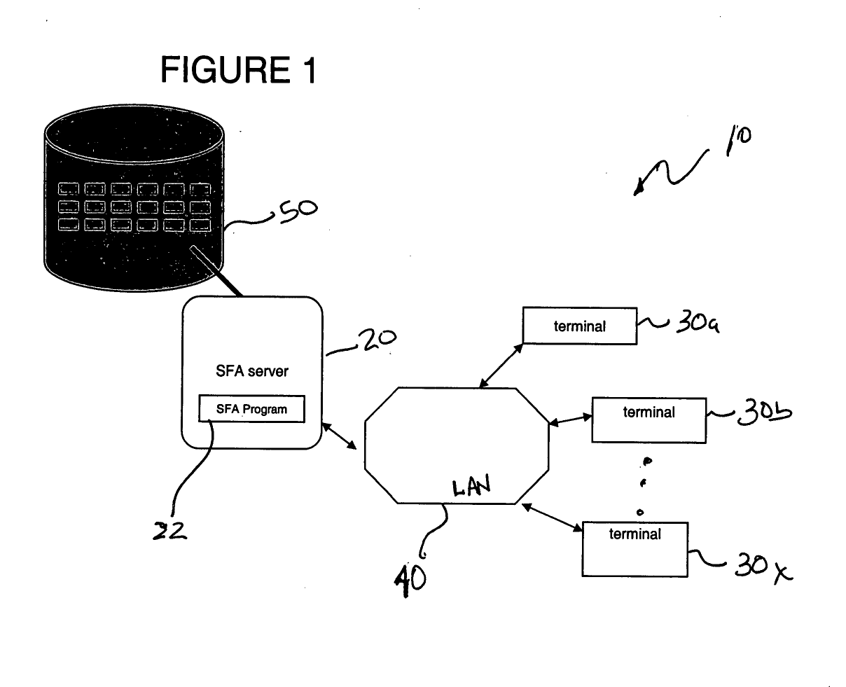

FIG. 1 illustrates a system including an operational database, illustrated as Sales Force Automation (SFA) system 10, suitable for use with the system and method of an illustrative embodiment of the invention. SFA systems are generally used by sales and marketing personnel to track any type of sales and marketing activity targeted at customers, prospects, suppliers, and other business contacts. The illustrative SFA system 10 includes an SFA server 20, an SFA database 50, and a plurality of terminals 30a-n. The SFA server 20 and terminals the 30a-30x may be connected via a network 40. The network 40 may be a local area network (LAN) 40, such as a company Intranet, a wide area network (WAN), such as the Internet or World Wide Web, a metropolitan area network (MAN) or another suitable network. The SFA server 20 hosts an SFA program for managing the entry, storage, organization and retrieval of data relating to sales activity. The SFA database 50 stores information entered by a sales personnel using a terminal 30 in an organized manner. The database 50 may be stored in the memory of the server 20 or may be a separate and remote component for storing data, as shown in FIG. 1. In some embodiments, the remote components stores data in a persistent manner.

The SFA system 10 helps individual sales representatives keep track of prospects, customers, and opportunities. A member of a sales team enters information relating to sales activity using a terminal 30, and the SFA program 22 automatically prompts for and organizes the information. The SFA system 10 can aggregate entered information and provide an instant measure of key sales metrics, such as revenue forecasts, sales pipeline and performance by sales representative, region, product line, and so on.

The SFA server 20 can comprise any suitable computer or device for hosting a sales force automation program. The SFA program enables a user to enter, organize, and select sales data stored in the database 50.

Each of the terminals 30 of the SFA system can comprise any suitable device for receiving and displaying information. Examples of types of terminals that can be connected to an SFA system include, but are not limited to, workstations, personal computers, telephones, including cell phones, and personal digital assistants.

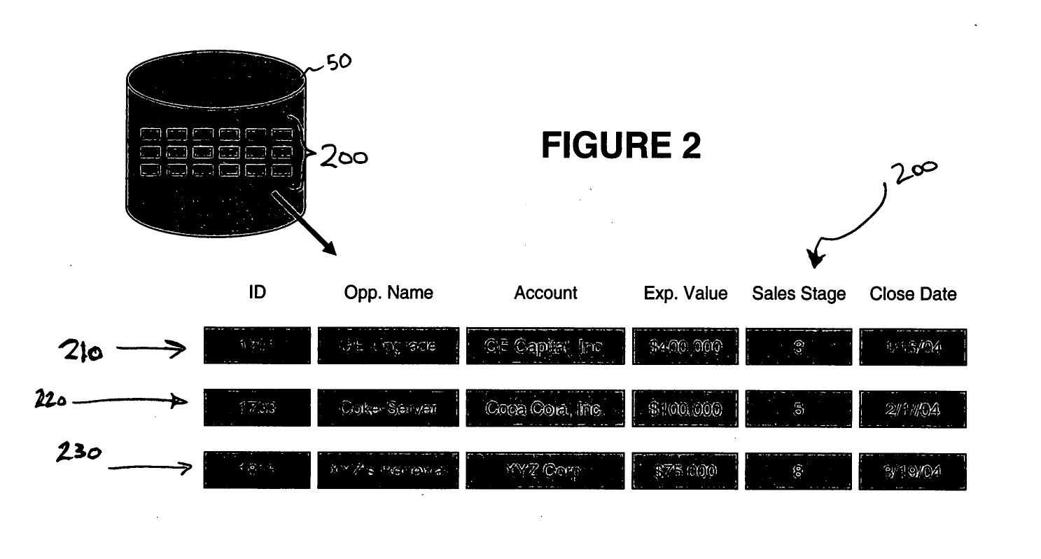

The database 50 may any suitable collection of information organized in any suitable format for allowing a computer program to access selected pieces of data. As shown in FIG. 2, an SFA system 10 may store data in the database 50 in the form of a table 200 listing data for different opportunities. Each opportunity represents a different deal or potential deal with a client or a potential client and is represented by one or more metrics. The user can specify different parameters to define the status of each opportunity. As shown, the table 200 includes a record 210, 220, 230 for each opportunity being tracked. The records include a number of fields corresponding to different parameters of each opportunity. The fields are populated with values defining the associated parameter for the opportunity.

In the illustrative embodiment, each opportunity has an identification number, an opportunity name, an account, an expected budget value (in dollars), a sales stage and a projected close date. Each opportunity is generally classified into one of several sales stages, with each sales stage representing the progress of the respective opportunity. A higher sales stage generally indicates that the deal is closer to completion, though one skilled in the art will recognize that, alternatively, a lower sales stage can be used to indicate that a deal is closer to completion. For example, in an illustrative embodiment of the invention, a sales stage of “01” signifies that the opportunity is a new lead, a sales stage of “02” signifies that the opportunity is a qualified lead”, a sales stage of “03” signifies that the opportunity is in the pipeline, a sales stage of “04” signifies that the opportunity is classified as upside, a sales stage of “05” signifies that a successful close to the deal is expected, a sales stage of “06” indicates that the client has committed to the deal, a sales stage of “07” signifies that the deal has closed and was won, and a sales stage of “08” signifies that the deal is dead and was lost. Different SFA implementations use different sales stages, customized to the type of product or service being sold, and to the stages in a typical sale.

One skilled in the art will recognize that any suitable format may be used to specify parameters of an opportunity and that the invention is not limited to the illustrative embodiment. For example, the sales stage may be classified using letters, symbols, words, or any other suitable format.

Within the SFA system 10, values in the fields are changed periodically to reflect a change in a parameter of the activity being tracked therein. For example, if a sales stage changes from a “04” to a “05”, a sales representative updates the “sales stage” field of the selected opportunity to reflect the progress. When parameters change, the SFA system 10 merely updates the records to reflect new values, oftentimes without maintaining a history or tracking changes in the data. However, maintaining a history or tracking changes in the data generally would require additional work by users, complicated data input, and more complex user interfaces, which would tend to deter use of the system.

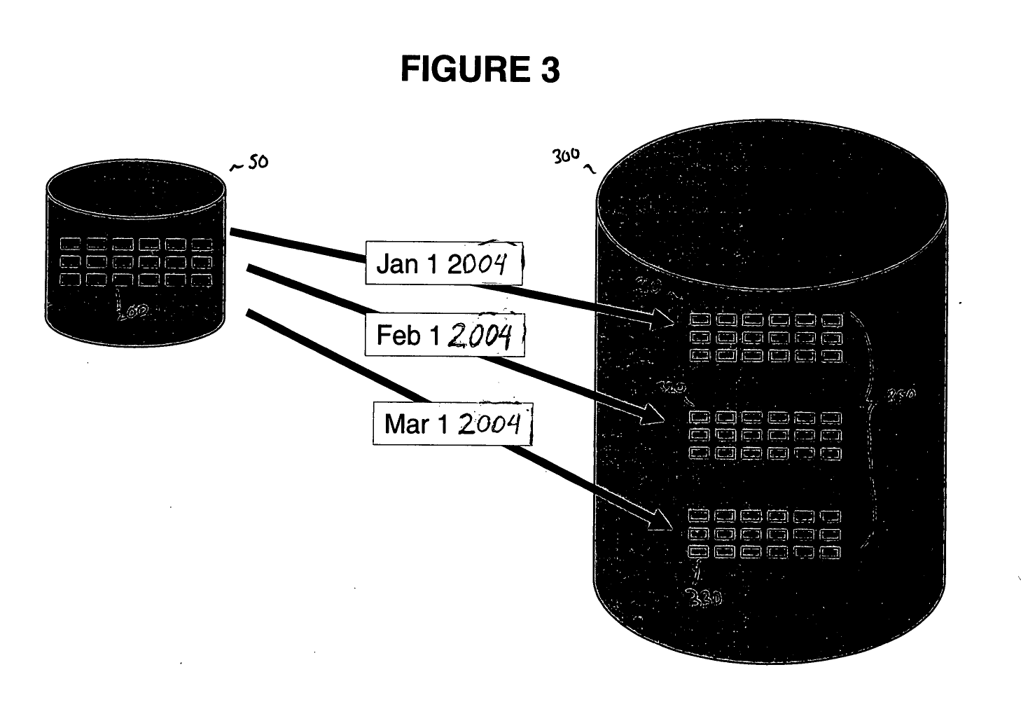

FIG. 3 illustrates a management system including an analytical database 200 of an illustrative embodiment of the invention for providing an analysis of data stored in an operational database, such as the SFA database 50 shown in FIGS. 1 and 2, over time. While the illustrative analytical database 300 manages and analyzes data from an SFA database, one skilled in the art will recognize that the analytical database may be used to manage and analyze data from any suitable operational database, such as an inventory control database, a human resources database, and other operational databases known in the art.

The analytical database 300 may be part of a management system that is connected to the SFA database 50 over a network. The management system includes a processor for controlling the operation of the analytical database 300, exercising requests for data from the operational database, analyzing data from the operational database and performing other calculations. A management program is also stored in the management system containing instructions for operating the processor.

To provide an analysis of data, the analytical database 300 periodically requests and receives snapshots of the operational database 50. As used herein, a “snapshot” refers to an instantaneous copy of a portion of the data stored in an operational database or a copy of the entire operational database. The copied data in each snapshot is time-stamped and saved in a data library 350 in the analytical database 300. The data library 350 may store the copied data from the operational database in any suitable format. The management processor manages the library 350, organizes data within the library, augments data, calculates new data, analyzes the data, presents the data in an effective manner and can link the analysis back to the SFA system, to enable a user to change data within the operational database in response to an analysis performed within the analytical database, as described in detail below.

The analytical database 300 may automatically request the snapshot at specified times, without users of operational database 50 being aware of the transfer of data. In this manner, the transfer and analysis of the data from the operation database can occur without disrupting or interfering with the operation of the operational database 50. An analysis of data stored in the operational database using the analytical database 300 can also occur covertly, to prevent users of the operational database from manipulating the data to influence the analysis performed by the management system. Alternatively, a manager of the operational database 50 can periodically send the snapshots to the analytical database 300 for analysis.

In an illustrative embodiment, the analytical database 300 requests and receives a copy of the data in the operational database 50 once per month. The first snapshot, taken on January 1, is stored in the library 350 as table 310. The second snapshot, taken February 1, is stored in the library 350 as table 320. The third snapshot, taken March 1, is stored in the library 350 as table 330, and so on. One skilled in the art will recognize that the snapshots may be taken at any suitable time interval. For example, the analytical database may take a snapshot of an operational database yearly, quarterly, monthly, weekly, daily, hourly, every minute, upon triggers indicating that a change has taken place in the operational database, and/or at another suitable time interval.

The time interval between snapshots can also be fixed or variable, depending on particular circumstances. For example, during a first time period, such as the first quarter of a year, the analytical database 300 may request and receive weekly snapshots of the operational database, while during a second period, such as the last quarter of the year, the analytical database 300 may request and receive daily snapshots of the operational database. The time interval between snapshots can be tailored through means known in the art for each particular application.

The analytical database 300 provides an analysis of the data in the operational database to provide insight into the activity, such as sales activity, tracked by the operational database. The analytical database 300 compares different snapshots 310, 320 and/or 330 of the operational database stored in the library 350 to identify changes within the operational database 50 over time. For example, the analytical database 300 can compare the same sales opportunity as it appears in different snapshots and identify changes to certain values of the opportunity to identify trends in the data, track performance, provide an accurate financial forecast and provide feedback to management.

In one embodiment, in addition to copying data directly from the operational database and storing the copied data within the analytical database, the management system also calculates and produces data, i.e., “calculated data” that does not appear in the operational database. Examples of calculated data include the date of each snapshot, as well as data reflecting changes in values for a particular opportunity between snapshots, such as a change in a sales stage between snapshots for a particular opportunity.

The data within the analytical database 300 may be stored using a proprietary data structure that is different from the data structure of the SFA database 50. The analytical database 200 organizes calculated data and copied data according to a selected data structure. Using copied data and calculated data, the analytical database 300 can create tables that enable analyses that are impossible or difficult to do directly from the SFA system 10. These tables can be linked back to the operational database or to another location to provide feedback regarding the activity within the operational database.

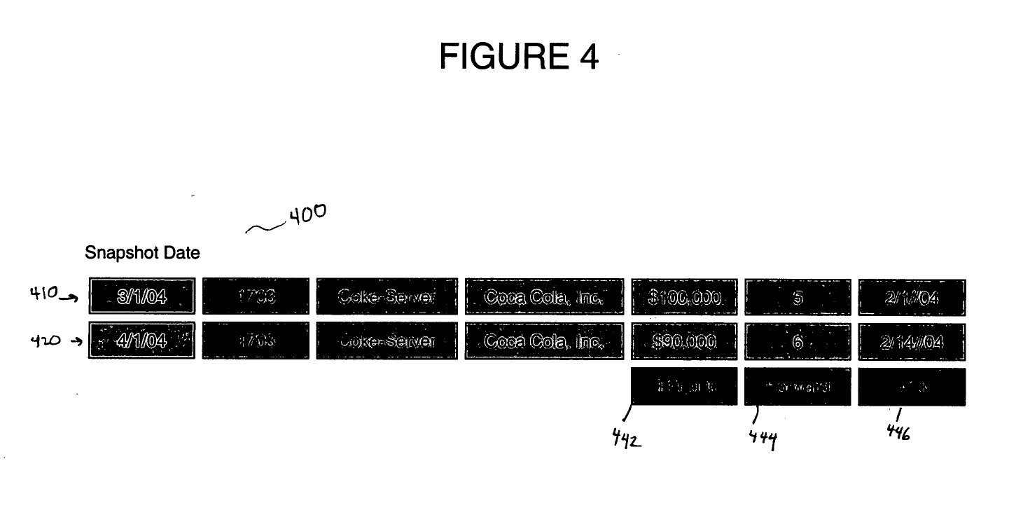

FIG. 4 illustrates an example of a table 400 within an analytical database for analyzing a particular opportunity over time. The table 400 includes a first record 410 for storing and organizing values reflecting the status of a selected opportunity at a first point in time (when a first snapshot is taken). The table also includes a second record 420 for storing and organizing values reflecting the status of the selected opportunity at a second point in time (when a second snapshot is taken). The table 400 includes certain fields having data copied directly from the operational database. The copied fields represent the instantaneous parameters for the opportunity at the time a snapshot was taken. A field is provided for time-stamping the date that the data was copied from the operational database. The table 400 also includes fields for storing calculated data identifying changes in the copied data between different snapshots to track changes in each opportunity over time. As shown in FIG. 4, a first change field 442 includes data representing a change in the expected financial budget or dollar value of the opportunity between the first snapshot date and the second snapshot date. A second change field 444 identifies progress in the sales stage, as described in detail below. A third change field 446 identifies a change in the expected close date for the particular opportunity.

As shown, the use of the analytical database 300 allows a manager or user of the operational database to identify not only the present status of an opportunity, but also the history of the opportunity and the changes in the opportunity over a prescribed time period. The user can also characterize the magnitude and type of changes undergone by an opportunity over a prescribed time period.

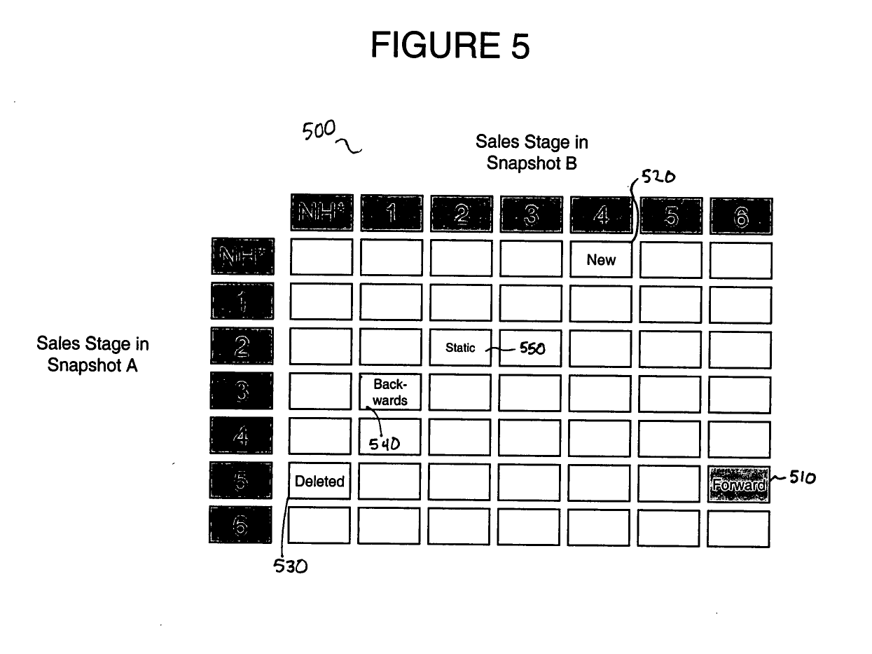

A reference tool can be used to classify changes in an opportunity or other feature or metric being tracked by an operational database. FIG. 5 illustrates an example of a reference tool, comprising a matrix 500, for classifying changes to a sales stage for a given opportunity. The rows of the illustrative matrix table 500 correspond to potential sales stages for an opportunity at a first point in time (snapshot A) and the columns of the matrix table 500 correspond to potential sales stages for an opportunity at a second point in time (snapshot B). The number of rows and columns is equal to the number of potential sales stages, including a sales stage of “NH”. The sales stage “NH” means that the particular opportunity did not appear in the operational database when the corresponding snapshot was taken.

The matrix 500 can be used to classify changes in a sales stage for different opportunities. For any two snapshots, a given opportunity has a defined position in snapshot A and a second defined position in snapshot B. The intersection of the position between the snapshots can be used to classify the type of change undergone by the opportunity. Each cell in the table represents a particular type of change in sales stage that can be undergone by an opportunity, and each cell can be assigned to a change group consisting of cells representing the same type of change. Types of changes in sales stage include, but are not limited to: a “forward” change, in which the sales stage advances, a “backward” change, in which the sales stage regresses, “won” in which the deal has been won, “deleted” in which the deal has been lost, “new” for an opportunity that has been added since the previous snapshot, and “static”, wherein the sales stage does not change between measured time periods.

The analytical database can use assigned sales stage change groups to identify what has changed in database over time. For example, an opportunity that is at a sales stage of “5” in snapshot A and a sales stage of “6” in snapshot, such as the opportunity tracked in the table in FIG. 4, be can be classified as undergoing a “FORWARD” change, as defined in cell 510. Based on the classification provided using the matrix, the analytical database can populate a field in a table describing the type of change undergone by the sales stage for the particular opportunity. For example, in the illustrative embodiment, the management system uses the matrix as a lookup table to determine that the opportunity tracked in the table of FIG. 4 has undergone a “FORWARD” change, and can populate the field 444 in the table of FIG. 4 with this value.

Each potential combination of sales stages between two different time periods can be classified using the matrix 500. As also shown in FIG. 5, an opportunity that is at a sales stage of NH in snapshot A and “4” in snapshot B can be classified as “NEW”, as defined in cell 520. An opportunity that has a sales stage of “5” in snapshot A and a sales stage of “NH” in snapshot B can be classified as “DELETED”, as shown in cell 530. An opportunity that has a sales stage of “3” in snapshot A and “1” in snapshot B is classified as undergoing a “BACKWARDS” change, as shown in cell 540. An opportunity that has a sales stage of “2” in both snapshot A and snapshot B is classified as “STATIC”, as shown in cell 550.

The assigned change group for an opportunity's change in sales stage can be a primary dimension for grouping opportunities to identify what has changed in operational database over time and allows the analytical database to show changes in easy-to-understand format. Using this grouping capability, for example, the analytic/analytical database could produce a report showing all opportunities that exhibited FORWARD changes in sales stage over the time period, and those opportunities could be aggregated to show forward changes by the representative, region, product or other parameter.

The matrix 500 can also be extended to a third dimension to allow classification of changes to values in an operational database over two or more time intervals.

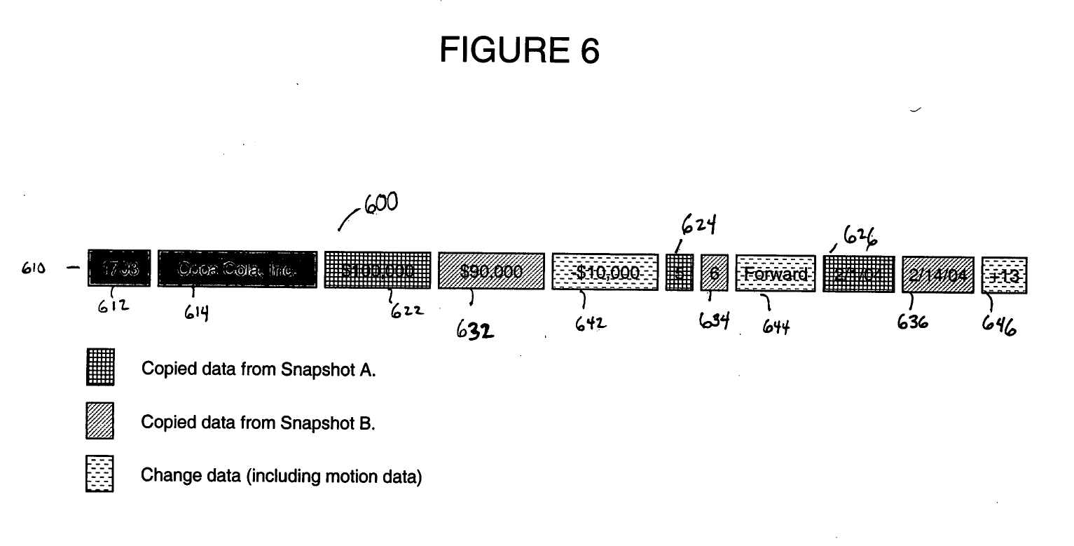

FIG. 6 is an example of a deal table 600 that can be created using data from the SFA system 10 according to an illustrative embodiment of the invention. The deal table 600 contains a record for each analyzed opportunity. Each record contains fields that describe the same parameter of an opportunity at different points in time, and includes fields that contain change data. While only one record 610 is shown in FIG. 6, one skilled in the art will recognize that the deal table can comprise any suitable number of records to store data corresponding to a corresponding number of opportunities.

The deal table 600 of FIG. 6 includes data that is directly copied from the first snapshot, data that is directly copied from the second snapshot and data that is calculated by the analytical database. As shown, selected fields list values of an opportunity that do not typically change. For example, fields 612 and 614 list the identification number and name, respectively, of the opportunity. The table also includes fields comprising data that is copied from snapshot A, for example, the expected value of the opportunity when snapshot A is taken (field 622), the sales stage of the opportunity when snapshot A is taken (field 624), and the expected close date for the opportunity (field 626) when snapshot A is taken. The table includes corresponding fields 632, 634, 636 storing values indicative of the status of the opportunity at the point in time when snapshot B is taken. Fields 642, 644 and 646 include change data representing a change in a selected value of an opportunity between the time when snapshot A is taken and the time when snapshot B is taken. As shown, field 642 shows the amount that the expected value of the opportunity has changed between snapshot A and snapshot B. Field 646 shows the number of days that the expected close date has changed between snapshot A and snapshot B. Field 644 includes data representing a change in the sales stage between snapshot A and snapshot B. As shown, field 644 includes the type of change undergone by the opportunity, which is calculating using a reference tool, such as the matrix 500 shown in FIG. 5.

While the examples shown in FIGS. 4-6 illustrates the comparison of values from two different snapshots, one skilled in the art will recognize that an analysis can be performed on data from any suitable number of snapshots of the operational database. The use of many snapshots over time provides change for a number of different pairs of copied data values. For example, for three snapshots, A, B, C, the analytical database calculates change data between the first and second snapshots A and B, between the second and third snapshots B and C, and between the first and third snapshots A and C to track change over the entire time period. Four snapshots would result in six different spans of change data, and so on.

The use of multiple change values for an opportunity allows analysis of a path of an opportunity over an extended time period. The comparison of multiple snapshots allows the analytical database to show the aggregate change of an opportunity between the first and last snapshot, as well as the sectional changes between each snapshot. Rather than only showing a change between a beginning and ending point, the path provides insight into how the values of the opportunity change in the time periods between.

For example, if five different snapshots are taken of an operational database over time, the analytical database can calculate that a particular opportunity had the following types of changes to the sales stage between the snapshots: NEW (snapshot A→snapshot B), FORWARD (snapshot B→snapshot C), FORWARD (snapshot C→snapshot D), LOST (snapshot D→snapshot E). This indicates that the sales person made consistent progress with the potential deal before losing the deal. A second opportunity can be tracked as, for example: (snapshot A→snapshot B), STATIC (snapshot B→snapshot C), FORWARD (snapshot C→snapshot D), WON (snapshot D→snapshot E). The second path indicates that the sales person made little initial progress before rapidly advancing and winning and closing the deal.

By tracking the path of an opportunity, the analytical database can identify where sales personnel had or tend to have trouble moving opportunity through different stages. The analytical database can also track and compare the path of a particular opportunity to the paths of other opportunities. Such a comparison allows the analytical database to more accurately predict an anticipated path and/or outcome of an opportunity by reviewing the path and/or outcome of prior opportunities that have undergone a similar pattern of change.

In addition to tracking the path of a particular opportunity, the analytical database can analyze trends by tracking the rate of change for different values of an opportunity.

The table provides useful reports that filter and group both copied data and change data in a manner that provides insight into the activity within the operational database.

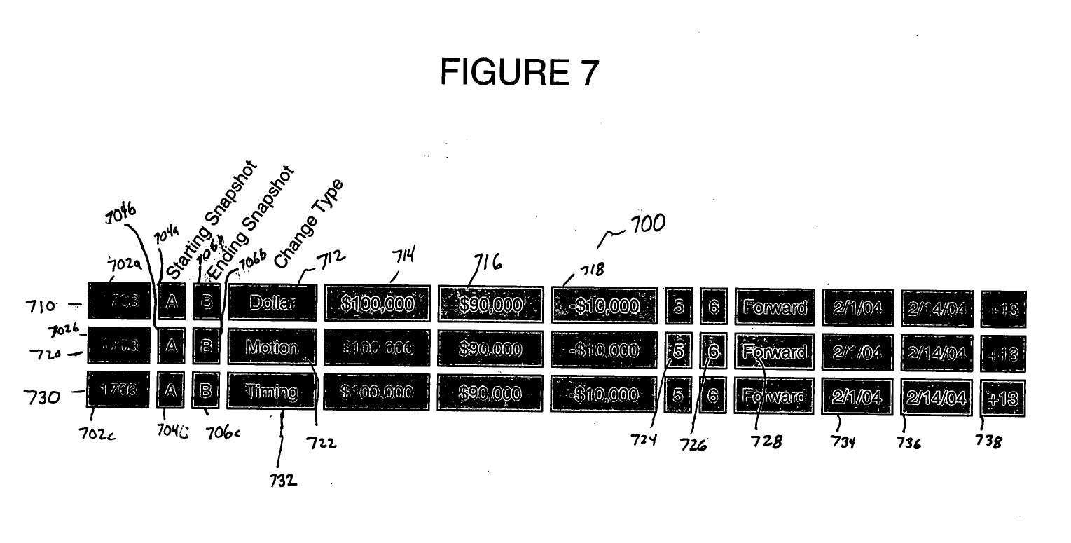

FIG. 7 illustrates another table 700 that can be generated using the management system of the illustrative embodiment of the invention. Each record 710, 720, 730 in the deal table 700 corresponds to a category of change, illustrated as a change in the expected value of the deal, a change in sales stage or a change in the expected close date, undergone by a given opportunity. Fields 702a, 702b, 702c contain data that identifies the identification number of an opportunity corresponding to the associated record. Fields 704a, 704b, 704c contain data identifying the initial snapshot and fields 706a, 706b, 706c contain data identifying the final snapshot.

For the first record 710, field 712 identifies the type of change that is evaluated in the first record, i.e., a change in the expected budget of the opportunity. Fields 714, 716 and 718 contain data showing the expected budget when snapshot A was taken, the expected budget when snapshot B was taken, and the change in the expected budget between the two points in time, respectively.

For the second record 720, field 722 identifies the type of change that is evaluated in the first record, i.e., a change in the sales stage the opportunity. Fields 724, 726 and 728 contain data showing the sales stage when snapshot A was taken, the sales stage when snapshot B was taken, and the change in the sales stage between the two points in time, respectively.

For the third record 730, field 732 identifies the type of change that is evaluated in the third record, i.e., a change in the expected close date of the opportunity. Fields 734, 736 and 738 contain data showing the expected close date when snapshot A was taken, the expected close date when snapshot B was taken, and the change in the expected close date between the two points in time, respectively.

One skilled in the art will recognize that the analytical database can be used to perform any suitable analysis on data stored in an operational database over time.

The analysis performed by the analytical database can be linked back to the source data, allowing users of the operational database to change source data in response to analysis. For example, the analytical database can provide a report providing an analysis of changes in the operational database to a terminal 30 of the SFA system. In one example, the analytical database can provide the report to a cell phone of a user, for example, to alert the user of negative changes in the database. In another example, the analysis is sent to a website, which can then be accessed by a user of the operational system to review the analysis performed by the analytical database. The reports can be provided in real-time, at predetermined time intervals, or upon the occurrence of a selected event, such as closing of a particular deal, or a backward change in a sales stage for a particular deal. The reports can also be provided to third parties. One skilled in the art will be able to determine an appropriate means and timing for reporting the results of the analysis to interested parties.

The analysis can be provided as a report in HTML format suitable for display by a browser application executing on the client. Suitable browser applications include Internet Explorer by Microsoft Corporation and other browser applications for use with a personal computer, the Web Browser for Palm and other browser applications for use with a personal digital assistant (PDA) and browser applications for mobile phones, including the Symbian web browser.

The analysis can also be passed to a multi-dimensional analysis tool, such as an online analytical processing (OLAP) database, for further analysis. An OLAP database is a relational database system capable of handling queries more complex than those handled by standard relational databases, through multidimensional access to data (viewing the data by several different criteria), intensive calculation capability, and specialized indexing techniques

The ability to copy and provide an analysis of data stored in an operational database without requiring additional input by users of the database and/or interfering with operation of the operational database has significant and valuable applications. By tracking changes in an operational database, the analytical database can evaluate the performance of programs and people. The analytical database can identify which marketing or sales programs or employees or partners tend to produce positive changes, such as advances in sales stage, increase in dollar amounts, or shortening of sales cycle, or which programs or employees tend to produce negative changes, such as move deals backwards through sales stages or lose deals, or decrease dollar amounts, or prolonged sales cycle. The analytical database can be used to show important trends, and to create a more accurate financial forecast. For example, the analysis can be used to show which opportunity paths are commonly associated with closed deals. Once typical paths to closed deals are known, the analytical database allows for the ability to look for current opportunities within the operational database that are exhibiting a similar kind or type of change, and are therefore more likely to result in revenue. The opportunities that are, based on comparison with prior opportunities, more likely to result in revenue can be weighed more than opportunities that are not. Such an analysis can provide a more accurate financial forecast than if all opportunities are treated the same, regardless of their type of change.

In another example, the analysis provided by the analytical database can be used to compare activity within different sales regions, to determine which sales regions are more likely to produce won deals. This allows for certain sales stages in selected regions to be weight differently than the same sales stage in a different region when calculating expected revenues.

The analytical database further allows for a diagnosis of changes in the marketplace, an identification of deals or other metrics that have been stagnant for an extended period of time, feedback on different selling techniques, an evaluation of sales effectiveness and many other advantages.

While the invention has been described relative to an operational database in an SFA system, the system and method for managing and analyzing data may be implemented and used with any suitable database-backed application that stores data that may change over time. Examples, of suitable systems include a human resources system for tracking employees, an inventory control system for tracking inventory, enterprise resource planning (ERP) applications, anti-terrorism applications, marketing automation applications, e-commerce applications and other database-backed website applications, inventory control and factory automation applications, customer service applications and others known in the art.

The present invention has been described relative to an illustrative embodiment. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

1. A method of managing data, comprising the steps of:
receiving, at a first point in time, a first copy of data stored in an operational database;
receiving, at a second point in time, a second copy of data stored in the operational database; and
comparing the first copy of data and the second copy of data to identify a change in the data stored in the operational database.

2. The method of claim 1, wherein the operational database stores the data as a plurality of values, each value stored in a field of a record.

3. The method of claim 2, wherein the step of comparing comprises identifying a change in a value stored in a field of a record of the database.

4. The method of claim 1, further comprising the step of sending a report identifying the change to the operational database.

5. The method of claim 1, further comprising the step of receiving, at a third point in time, a third copy of data from the operational database.

6. The method of claim 5, further comprising the step of comparing said first copy of data and said third copy of data to identify a change in the data between the first point in time and the third point in time.

7. The method of claim 5, further comprising the step of comparing said second copy of data and said third copy of data to identify a change in the data between the second point in time and the third point in time.

8. The method of claim 1, wherein the operational database comprises a sales force automation system.

9. The method of claim 8, wherein the step of comparing comprises comparing a sales stage of an opportunity at the first point in time with a sale stage of the opportunity at the second point in time.

10. The method of claim 9, further comprising the step of classifying a type of change undergone by the opportunity using a reference tool.

11. The method of claim 10, further comprising the step of populating a field of a table with information representative of the type of change undergone by the opportunity.

12. An article of manufacture having computer-readable program means embodied thereon for managing data, the article comprising:
computer-readable program means for receiving, at a first point in time, a first copy of data from an operational database;
computer-readable program means for receiving, at a second point in time, a second copy of data from the operational database; and
computer-readable program means for comparing said first copy of data and second copy of data to provide a report identifying a change in the data between the first point in time and the second point in time.

13. A method of managing data, comprising the steps of:
receiving, at a first point in time, a first copy of data stored in an operational database,
receiving, at a second point in time, a second copy of data stored in the operational database;
comparing the first copy of data and the second copy of data to identify a change in the data stored in the operational database; and
entering a report identifying the change into a multidimensional analysis tool.

14. The method of claim 13, further comprising the step of analyzing the report using the multidimensional analysis tool.

15. An article of manufacture having computer-readable program means embodied thereon for managing data, the article comprising:
computer-readable program means for receiving, at a first point in time, a first copy of data from an operational database;
computer-readable program means for receiving, at a second point in time, a second copy of data from the operational database;
computer-readable program means for comparing said first copy of data and second copy of data to provide a report identifying a change in the data between the first point in time and the second point in time; and
computer-readable program means for entering a report identifying the change into a multidimensional analysis tool.

16. A method of managing transactional information relating to sales opportunities, comprising the steps of:
receiving and storing a first copy of data from a SFA database;
receiving and storing a second copy of data from the SFA database after a predetermined time period; and
identifying changes to the data stored in the SFA database over the predetermined time period.

17. The method of claim 16, wherein the data is representative of one or more sales opportunities.

18. The method of claim 17, wherein the data includes a sales stage of each of said one or more sales opportunities.

19. The method of claim 18, further comprising the step of classifying a type of change undergone by the sales stage of each of said one or more sales opportunities.

20. The method of claim 16, further comprising the step of providing a report identifying the changes to a multidimensional analysis tool.

21. An article of manufacture having computer-readable program means embodied thereon for managing data, the article comprising:
computer-readable program means for receiving and storing a first copy of data from a SFA database;
computer-readable program means for receiving and storing a second copy of data from the SFA database after a predetermined time period; and
computer-readable program means for identifying changes to the data stored in the SFA database over the predetermined time period.

22. A method of managing data, comprising the steps of:
storing, at a database, information indicative of a sales opportunity;
executing at a database, a query producing a plurality of records including all stales opportunities stored in the database;
storing, at a first time period, the plurality of records at a data management server;
updating the plurality of records in the database; and
storing, at a second time period, the updated plurality of records at the data management server.

23. The method of claim 22, further comprising the step of:
identifying changes in the records between the first time period and the second time period.

24. The method of claim 23, further comprising the step of:
producing a report that identifies the changes in the records.

25. The method of claim 24, further comprising the step of transmitting the report to the database.

26. The method of claim 24, further comprising the step of transmitting the report to a multidimensional analysis tool.
